(19) United States
(12) Patent Application Publication
(10) Pub. No.: US 2020/0409018 A1
(43) Pub. Date: Dec. 31, 2020

(54) LENS MODULE

(71) Applicant: AAC Optics Solutions Pte. Ltd., Singapore City (SG)

(72) Inventor: Chuandong Wei, Shenzhen (CN)

(21) Appl. No.: 16/914,489

(22) Filed: Jun. 29, 2020

(30) Foreign Application Priority Data
Jun. 29, 2019 (CN) PCT/CN2019/094028

(51) Int. Cl. G02B 7/02; G02B 13/00

(52) U.S. Cl. CPC G02B 7/021; G02B 13/0045; G02B 7/026; G02B 7/025

(57) ABSTRACT

A lens module is provided, including a lens barrel with an accommodation space and a lens group; the lens barrel includes a first barrel wall and a second barrel wall; the lens module includes an annular supporting member fixed to one end of the second barrel wall adjacent to an image side; the annular supporting member including an inner surface adjacent to an optical axis, the second barrel wall including an inner side surface adjacent to the optical axis, and the first barrel wall jointly surround to form the accommodation space; and a minimum distance between the inner surface of the annular supporting member and the optical axis is greater than a maximum distance between the inner side surface of the second barrel wall and the optical axis. Compared with the related technology, the lens module provided in the present disclosure has better imaging quality and good reliability.

### TECHNICAL FIELD

The present disclosure relates to the field of optical imaging, in particularly to a lens module.

### BACKGROUND

In recent years, with the continuous development of science and technology, electronic devices are continuously developing towards intelligence. In addition to digital cameras, portable electronic devices such as tablet computers and mobile phones are also equipped with lens modules having photo shooting and video shooting functions, as well as vehicles such as cars are equipped with the lens modules having the photo shooting and video shooting functions, so as to meet the needs of users to take photos at any time.

The lens module in the related technology includes a lens barrel and a lens group accommodated in the lens barrel. In order to enable the lens barrel to support and fix the lens group sufficiently and satisfy requirements on a molding thickness of the plastic lens barrel, a side wall of the lens barrel usually needs to reach a certain thickness. For the lens barrel with too thick side wall, as shown in FIG. 1, due to a reflection effect of the inner wall of the lens barrel on the light, the light emitted to the lens group from various angles is easy to form stray light interference in the lens barrel during an imaging. In particular, one end of the side wall of the lens barrel that is adjacent to an image side is a part where external light is very easy to reflect after entering the lens barrel, thus obvious stray light is easy to appear in the photographed picture, resulting in poor imaging quality of the lens module.

Therefore, it is necessary to provide an improved lens module to solve the above problems.

### SUMMARY

With respect to the technical problem that a lens is easy to generate stray light due to a light reflection effect of an inner wall of a lens barrel in a lens module in the related technology which causes poor imaging quality of the lens module, the present disclosure provides a lens module which is able to prevent the stray light effectively and has good reliability.

A lens module, which includes a lens barrel with an accommodation space and a lens group accommodated in the accommodation space; the lens barrel including a first barrel wall configured with a light through hole and a second barrel wall bending and extending from an outer side of the first barrel wall; the lens module further including an annular supporting member fixed to one end of the second barrel wall that is adjacent to an image side; the annular supporting member, the second barrel wall, and the first barrel wall jointly surrounding to form the accommodation space; the second barrel wall including an inner side surface adjacent to an optical axis; the annular supporting member including an inner surface adjacent to the optical axis; and a minimum distance between the inner surface of the annular supporting member and the optical axis being greater than a maximum distance between the inner side surface of the second barrel wall and the optical axis.

Preferably, the second barrel wall further includes an outer side surface away from the optical axis, an end surface adjacent to the image side, and a step portion formed at the outer side surface and connected with the end surface; the step portion surrounds the accommodation space; and the annular supporting member abuts against and fixed on the step portion.

Preferably, the step portion includes a receiving surface connected with the outer side surface and extending horizontally in a direction adjacent to the optical axis, and a stop surface extending vertically from the receiving surface in the direction adjacent to the image side and connected with the end surface.

The annular supporting member further includes a top surface adjacent to an object side and connected with the inner surface; the top surface abuts against the receiving surface, and the inner surface partially abuts against the stop surface.

Preferably, the inner surface includes a first surface connected with the top surface and abutting against the stop surface, a second surface extending horizontally from the first surface in the direction adjacent to the optical axis and abutting against the end surface, a third surface extending vertically from the second surface in the direction adjacent to the image side, a fourth surface extending horizontally from the third surface in the direction away from the optical axis, and a fifth surface extending vertically from the fourth surface in the direction adjacent to the image side.

The second surface abuts against the end surface and partially covers the end surface, an uncovered portion of the end surface forms a stepped structure with the third surface, the fourth surface, and the fifth surface; and the stepped structure serves as a dispensing groove for fixing the annular supporting member to the second barrel wall.

Preferably, the inner surface includes a sixth surface connected with the top surface and abutting against the stop surface, a seventh surface extending horizontally from the sixth surface in the direction away from the optical axis, and an eighth surface extending vertically from the seventh surface in the direction adjacent to the image side.

The eighth surface and the stop surface are arranged at intervals; the eighth surface, the seventh surface and the stop surface cooperate to surround a first groove; and the first groove serves as a dispensing groove for fixing the annular supporting member to the second barrel wall.

Preferably, the step portion includes a first supporting surface connected with the outer side surface and extending horizontally in a direction adjacent to the optical axis, a first stop surface extending vertically from the first supporting surface in the direction adjacent to the image side, a second supporting surface extending horizontally from the first stop surface in the direction adjacent to the optical axis, and a second stop surface extending vertically from the second supporting surface in the direction adjacent to the image side and connected with the end surface.

The annular supporting member further includes a top surface adjacent to an object side and connected with the inner surface; the top surface abuts against the first supporting surface; and the inner surface includes a first inner surface connected with the top surface and abutting against the first stop surface, a second inner surface extending horizontally from the first inner surface in the direction adjacent to the optical axis, a third inner surface extending vertically from the second inner surface in the direction adjacent to the image side and abutting against the second stop surface, a fourth inner surface extending horizontally from the third inner surface in the direction away from the optical axis, and a fifth inner surface extending vertically from the fourth inner surface in the direction adjacent to the image side.

The fifth inner surface and the second stop surface are arranged at intervals; the fifth inner surface, the fourth inner surface and the second stop surface cooperate to surround a second groove; and the second groove serves as a dispensing groove for fixing the annular supporting member to the second barrel wall.

Preferably, the annular supporting member is made of a metal or plastic.

Preferably, the annular supporting member and the second barrel wall are fixed by glue.

Preferably, the lens module further includes a press ring that holds the lens group in the accommodation space; and the press ring abuts against the inner side surface of the second barrel wall.

Preferably, a third groove is formed between one side of the press ring that is adjacent to an image plane and the inner side surface of the second barrel wall; the third groove is filled with an adhesive; and the press ring is fixed to the second barrel wall by the adhesive.

Compared with the related technology, in the lens module according to the present utility model, the annular supporting member is provided at one end of the lens barrel that is adjacent to the image side, the annular supporting member and the lens barrel cooperate to surround the accommodation space for accommodating the lens group, and the minimum distance between the inner surface of the annular supporting member and the optical axis is greater than the maximum distance between the inner side surface of the second barrel wall and the optical axis, which may effectively reduce a case where stray light is incident into the lens barrel and reflected on the annular supporting member thus affecting imaging quality, thereby reducing the stray light phenomenon inside the lens group and effectively improving the imaging quality. The annular supporting member and the second barrel wall may be cooperatively fixed by various means, and different dispensing fixation modes are used, which ensures flexibility of the design of the lens barrel bottom for free replacement and ensures good support of the lens barrel to the lens group for good reliability.

### BRIEF DESCRIPTION OF THE DRAWINGS

In order to illustrate the technical solution in the embodiments of the present disclosure more clearly, the accompanying drawings used in the description of the embodiments are briefly introduced below. It is apparent that the drawings descripted below are only some embodiments of the present disclosure. For those skilled in the art, other drawings may be obtained in accordance with these drawings without any creative work, where:

FIG. 1 is a cross-sectional view of a lens module in the related technology;

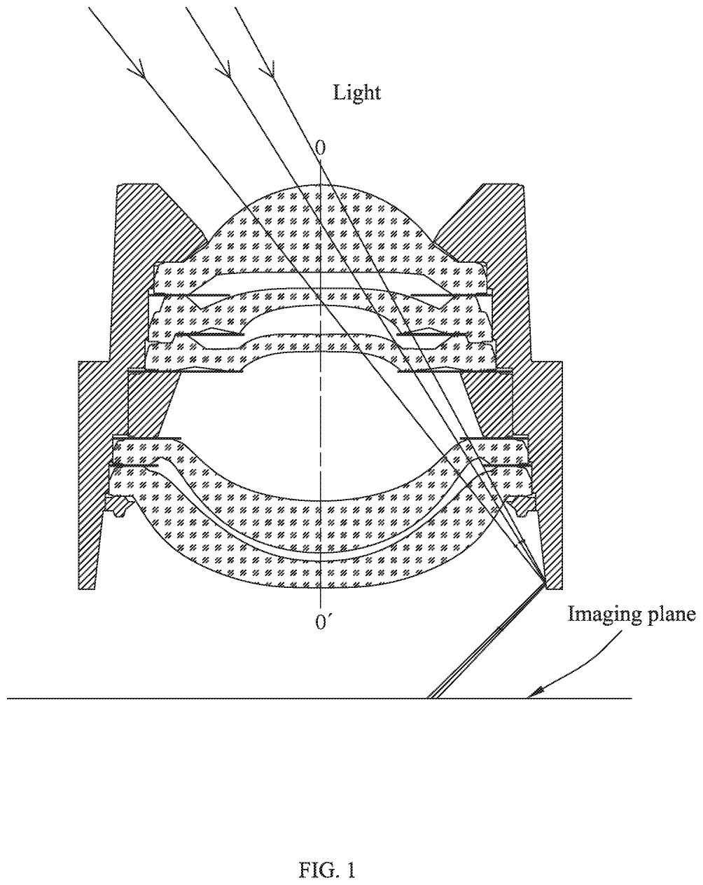

FIG. 2 is a cross-sectional view of the lens module provided in Embodiment 1 of the present disclosure;

FIG. 3 is a partially exploded schematic diagram of the lens module shown in FIG. 2;

FIG. 4 is a partially enlarged view of a portion A of the lens module shown in FIG. 3;

FIG. 5 is a cross-sectional view of the lens module provided in Embodiment 2 of the present disclosure;

FIG. 6 is a partially exploded schematic diagram of the lens module shown in FIG. 5;

FIG. 7 is a partially enlarged view of a portion B of the lens module shown in FIG. 6;

FIG. 8 is a cross-sectional view of the lens module provided in Embodiment 3 of the present disclosure;

FIG. 9 is a partially exploded view of the lens module shown in FIG. 8; and

FIG. 10 is a partially enlarged view of a portion C of the lens module shown in FIG. 9.

### DETAILED DESCRIPTION

The technical solutions in the embodiments of the present disclosure will be clearly and completely described with reference to the accompanying drawings in the present disclosure. It is evident that the embodiments described are only some rather than all embodiments in the present disclosure. Based on the embodiments in the present disclosure, all other embodiments obtained by those of ordinary skills in the art without any creative work shall fall within the protection scope of the present disclosure.

### Embodiment 1

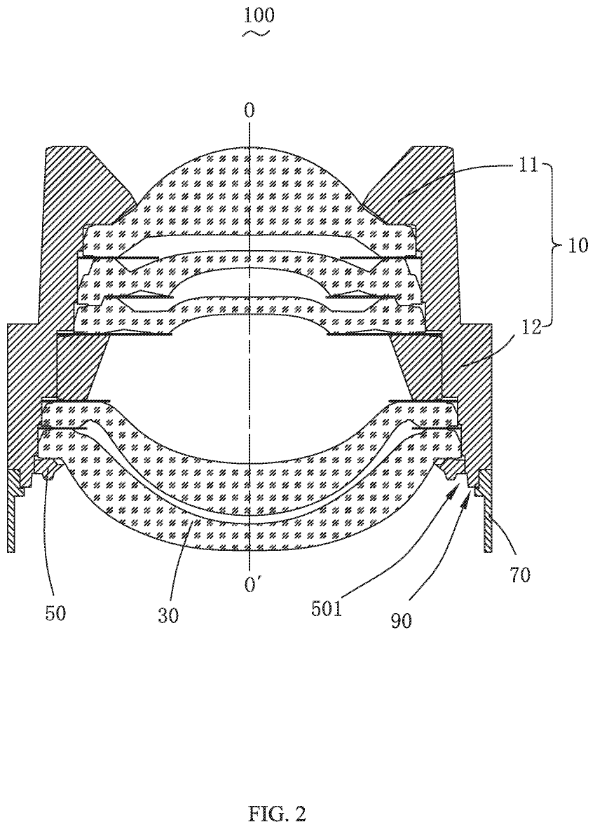

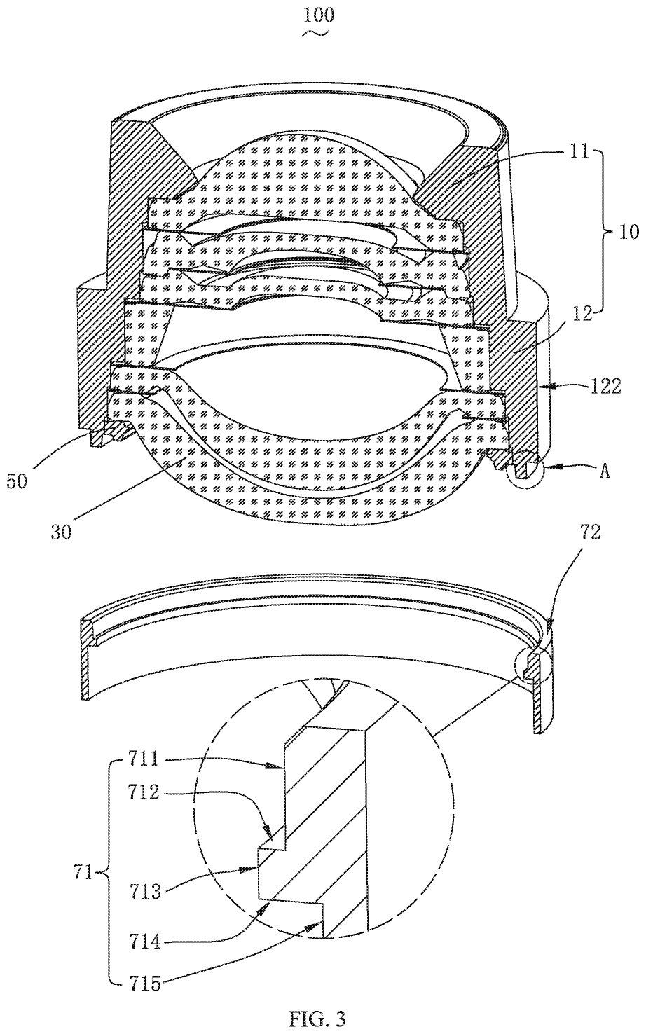

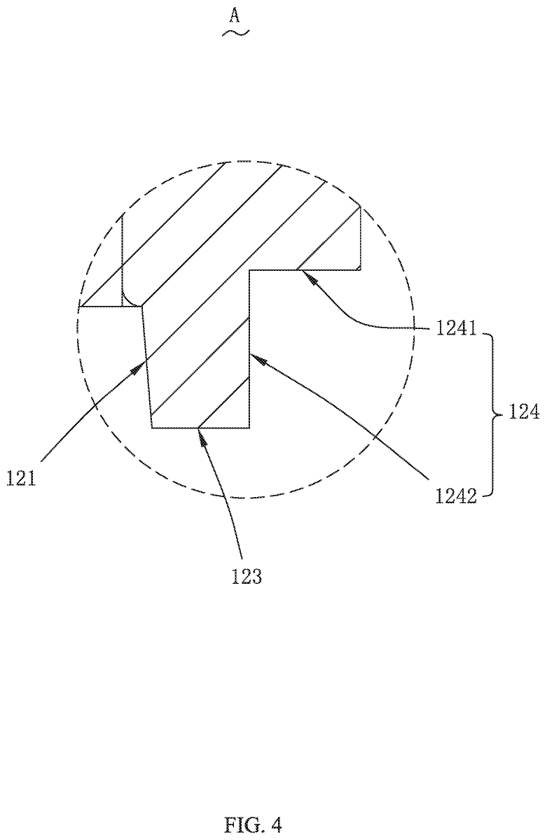

Referring to FIG. 2 to FIG. 4. This embodiment provides a lens module 100, which includes a lens barrel 10, a lens group 30 accommodated in the lens barrel 10, a press ring 50 that holds the lens group 30 in the lens barrel 10, and an annular supporting member 70 fixed to one end of the lens barrel 10 that is adjacent to an image side.

The lens barrel 10 includes a first barrel wall 11 configured with a light through hole and a second barrel wall 12 bending and extending from the first barrel wall 11. The annular supporting member 70 is fixed to one end of the second barrel wall 12 that is adjacent to the image side. The annular supporting member 70, the second barrel wall 12 and the first barrel wall 11 jointly surround to form an accommodation space. The accommodation space is configured to accommodate the lens group 30. And the lens group 30 is sandwiched between the lens barrel 10 and the press ring 50.

The second barrel wall 12 includes an inner side surface 121 adjacent to an optical axis 00′, an outer side surface 122 away from the optical axis 00′, an end surface 123 adjacent to the image side, and a step portion 124 formed at the outer side surface 122 and connected with the end surface 123. The step portion 124 surrounds the accommodation space. And the annular supporting member 70 abuts against and is fixed on the step portion 124.

The annular supporting member 70 includes an inner surface 71 adjacent to the optical axis 00′ and a top surface 72 adjacent to an object side and connected with the inner surface 71.

A minimum distance between the inner surface 71 of the annular supporting member 70 and the optical axis 00′ is greater than a maximum distance between the inner side surface 121 of the second barrel wall 12 and the optical axis 00′. Since one end of the lens barrel 10 that is adjacent to the image side is a portion where reflection is very likely to occur after external light enters the lens barrel 10, in the present disclosure, the minimum distance between the inner surface 71 of the annular supporting member 70 and the optical axis 00′ is set to be greater than the maximum distance between the inner side surface 121 of the second barrel wall 12 and the optical axis 00′. That is, a thickness of the annular supporting member 70 is very thin, which may effectively reduce a case where stray light is incident into the lens barrel and reflected on the annular supporting member thus affecting imaging quality, thereby reducing the stray light phenomenon inside the lens group and effectively improving the imaging quality.

The step portion 124 includes a receiving surface 1241 connected with the outer side surface 122 and extending horizontally in a direction adjacent to the optical axis 00′, and a stop surface 1242 extending vertically from the receiving surface 1241 in the direction adjacent to the image side and connected with the end surface 123.

The inner surface 71 includes a first surface 711 connected with the top surface 72 and abutting against the stop surface 1242, a second surface 712 extending horizontally from the first surface 711 in the direction adjacent to the optical axis 00′ and abutting against the end surface 123, a third surface 713 extending vertically from the second surface 712 in the direction adjacent to the image side, a fourth surface 714 extending horizontally from the third surface 713 in the direction away from the optical axis 00′, and a fifth surface 715 extending vertically from the fourth surface 714 in the direction adjacent to the image side. That is, a circle of protrusion structure is formed on the inner surface 71 of the annular supporting member 70, and the protrusion structure may support the second barrel wall 12 and cooperate to fix the annular supporting member 70 and the second barrel wall 12 into a whole. Specifically, the second surface 712 abuts against the end surface 123 and partially covers the end surface 123. An uncovered portion of the end surface 123 forms a stepped structure 90 with the third surface 713, the fourth surface 714, and the fifth surface 715. The stepped structure 90 serves as a dispensing groove for fixing the annular supporting member to the second barrel wall. During assembly, glue may be injected into the dispensing groove so as to fix the annular supporting member 70 to the second barrel wall 12.

The annular supporting member 70 is made of a metal or plastic material, and may achieve sufficient support strength.

The press ring 50 abuts against the inner side surface 121 of the second barrel wall 12. A third groove 501 is formed between one side of the press ring 50 that is adjacent to an image plane and the inner side surface 121 of the second barrel wall 12. The third groove 501 is filled with an adhesive. The press ring 50 is fixed to the second barrel wall 12 by the adhesive. Preferably, the press ring 50 and the second barrel wall 12 are fixed by glue.

### Embodiment 2

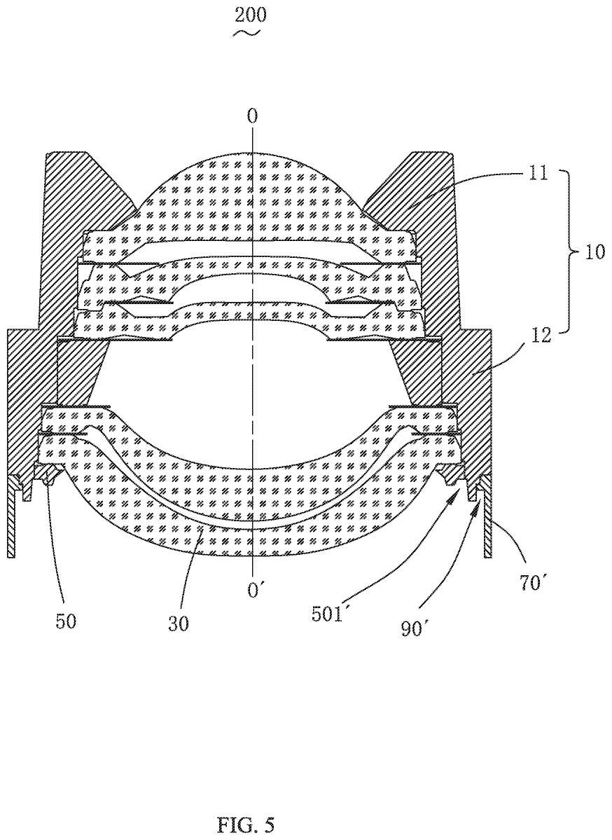

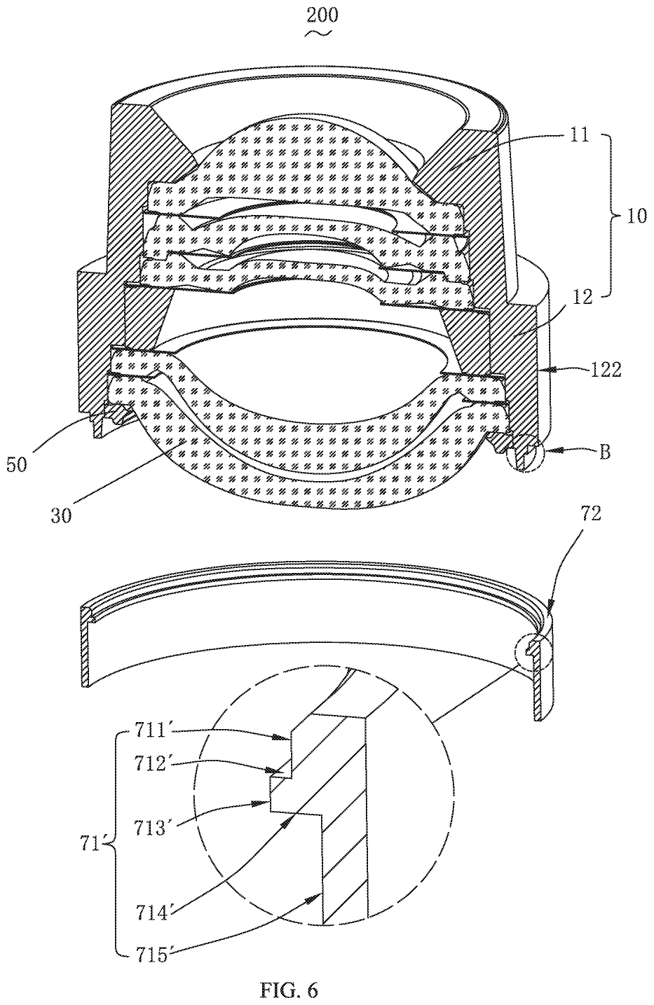

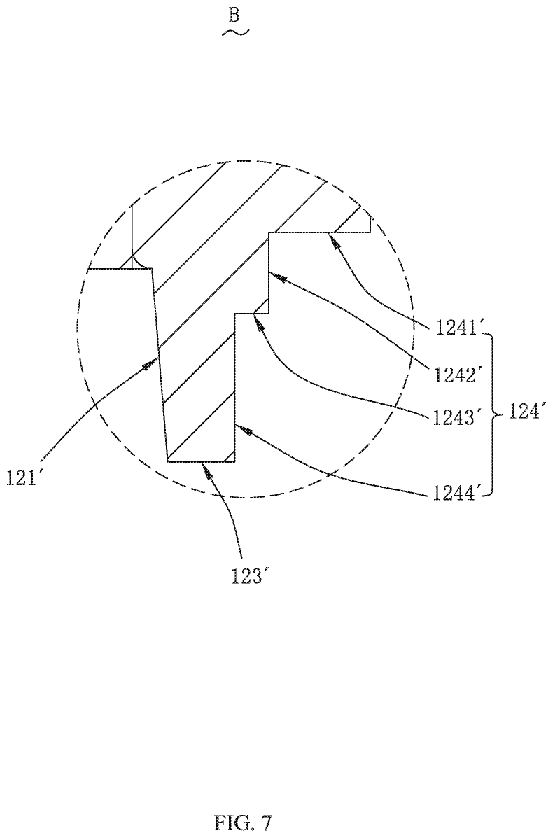

Referring to FIG. 5 to FIG. 7, which are schematic diagrams showing a second embodiment of a lens module provided in the present disclosure. A structure according to Embodiment 2 is integrally the same as the structure according to Embodiment 1. The main difference is that the structure of a step portion 124′ and a cooperating mode of an annular supporting member 70′ and a second barrel wall 12 are different from that according to Embodiment 1. A step portion 124 according to Embodiment 1 includes only one supporting surface, while the step portion 124′ according to this embodiment includes two supporting surfaces, that is, the step portion 124′ according to this embodiment is a double-layer step.

Specifically, the step portion 124′ includes a first supporting surface 1241′ connected with an outer side surface 122′ and extending horizontally in the direction adjacent to the optical axis 00′, a first stop surface 1242′ extending vertically from the first supporting surface 1241′ in the direction adjacent to the image side, a second supporting surface 1243′ extending horizontally from the first stop surface 1242′ in the direction adjacent to the optical axis 00′, and a second stop surface 1244′ extending vertically from the second supporting surface 1243′ in the direction adjacent to the image side and connected with the end surface 123′.

A top surface 72′ of the annular supporting member 70′ abuts against the first supporting surface 1241′. An inner surface 71′ includes a first inner surface 711′ connected with the top surface 72′ and abutting against the first stop surface 1242′, a second inner surface 712′ extending horizontally from the first inner surface 711′ in the direction adjacent to the optical axis 00′, a third inner surface 713′ extending vertically from the second inner surface 712′ in the direction adjacent to the image side and abutting against the second stop surface 1244′, a fourth inner surface 714′ extending horizontally from the third inner surface 713′ in the direction away from the optical axis 00′, and a fifth inner surface 715′ extending vertically from the fourth inner surface 714′ in the direction adjacent to the image side.

The fifth inner surface 715′ and the second stop surface 1244′ are arranged at intervals. The fifth inner surface 715′, the fourth inner surface 714′ and the second stop surface 1244′ cooperate to surround a second groove 90′. And the second groove 90′ serves as a dispensing groove for fixing the annular supporting member 70′ to the second barrel wall 12.

In this embodiment, the step portion 124′ of the second barrel wall 12 is set as a double-layer step, such that fixation between the annular supporting member 70′ and the second barrel wall 12 is more stable, which improves the reliability of the product and is favorable for setting the thickness of the annular supporting member 70′ to be thinner, thus better preventing stray light from being incident onto the annular supporting member 70′.

The press ring 50 abuts against an inner side surface 121′ of the second barrel wall 12. A third groove 501′ is formed between one side of the press ring 50 that is adjacent to the image plane and the inner side surface 121′ of the second barrel wall 12. The third groove 501′ is filled with an adhesive. And the press ring 50 is fixed to the second barrel wall 12 by the adhesive. Preferably, the press ring 50 and the second barrel wall 12 are fixed by glue.

### Embodiment 3

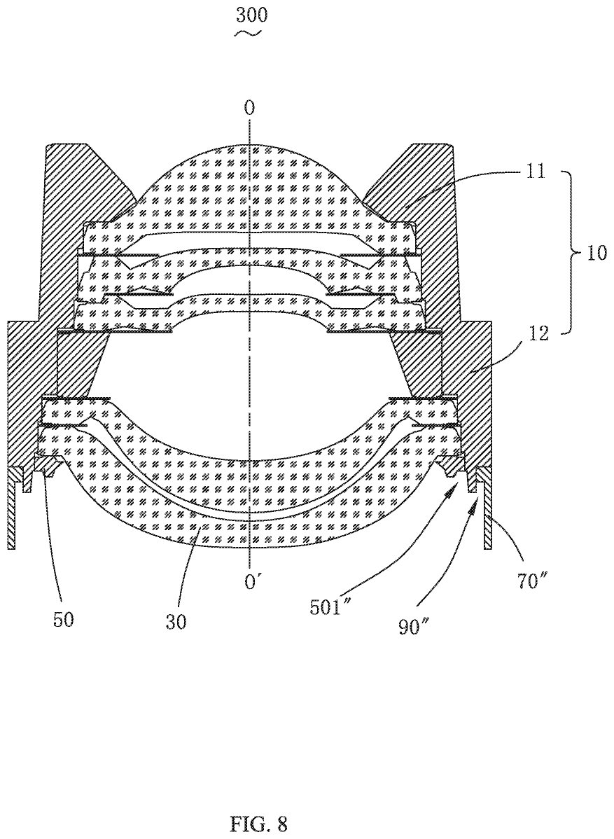

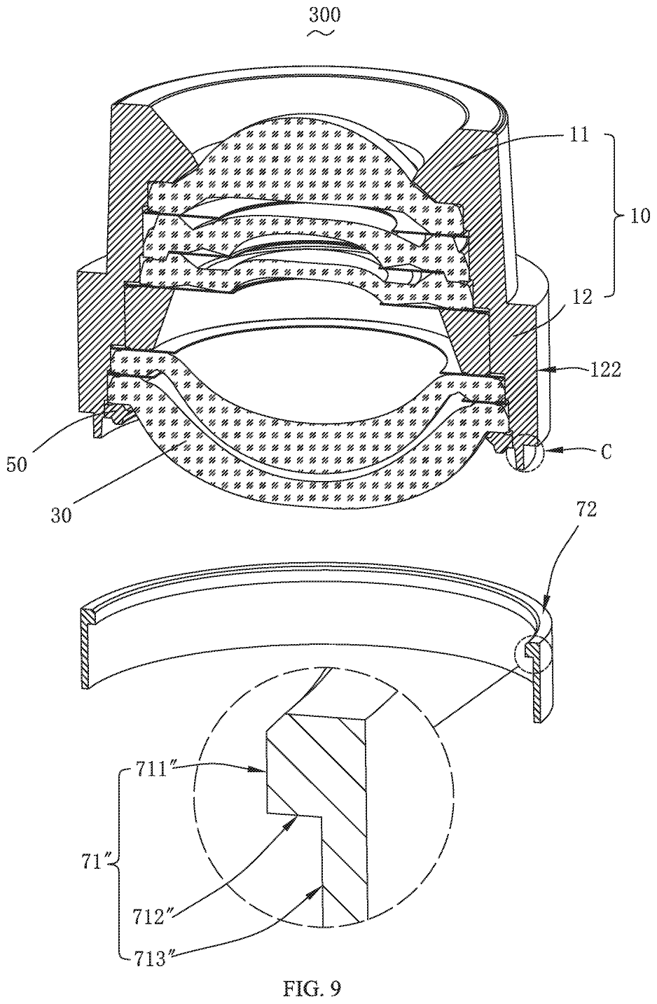

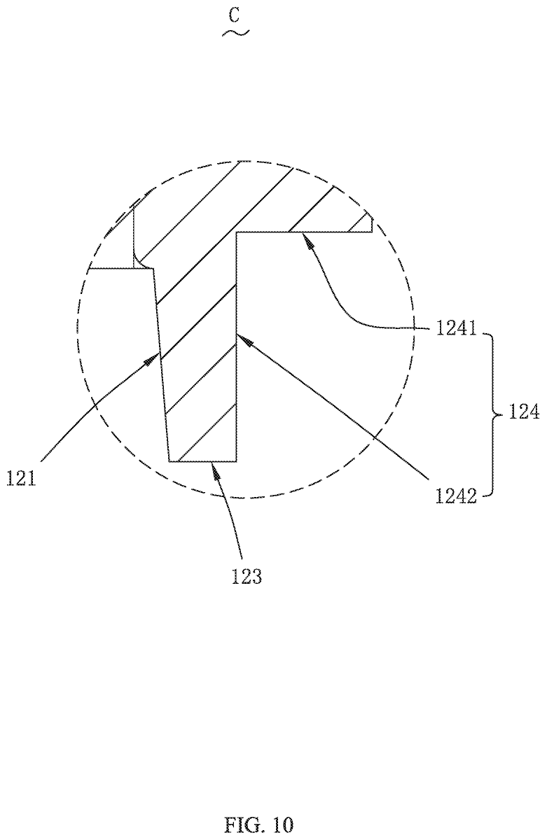

Referring to FIG. 8 to FIG. 10, which are schematic diagrams showing a third embodiment of a lens module provided in the present disclosure. A structure according to Embodiment 3 is integrally the same as the structure according to Embodiment 1. And the main difference is that the structure of an inner surface 71″ of an annular supporting member 70″ and a cooperating mode of the annular supporting member 70″ and a second barrel wall 12 are different.

In this embodiment, a cross section of the annular supporting member 70″ has an inverted-L shape. Specifically, the inner surface 71″ includes a sixth surface 711″ connected with a top surface 72 and abutting against a stop surface 1242, a seventh surface 712″ extending horizontally from the sixth surface 711″ in the direction away from the optical axis 00f, and an eighth surface 713″ extending vertically from the seventh surface 712″ in the direction adjacent to the image side.

The structure of a step portion 124 of the second barrel wall 12 is the same as that according to Embodiment 1, which are not repeated here in details.

After assembly, the top surface 72 of the annular supporting member 70″ abuts against a receiving surface 1241. The sixth surface 711″ abuts against the stop surface 1242. The eighth surface 713″ is arranged at intervals with the stop surface 1242. The eighth surface 713″, the seventh surface 712″ and the stop surface 1242 cooperate to surround a first groove 90″. The first groove 90″ serves as a dispensing groove for fixing the annular supporting member 70″ to the second barrel wall 12.

In this embodiment, the cross section of the annular supporting member 70″ is arranged in the inverted-L shape, which is convenient for processing and is also favorable for setting the annular supporting member 70″ to be thinner.

A lens module 300 further includes a press ring 50 that holds a lens group 30 in an accommodation space. The press ring 50 abuts against an inner side surface 121 of the second barrel wall 12. A third groove 501″ is formed between one side of the press ring 50 that is adjacent to the image plane and the inner side surface 121 of the second barrel wall 12. The third groove 501″ is filled with an adhesive. And the press ring 50 is fixed to the second barrel wall 12 by the adhesive. Preferably, the press ring 50 and the second barrel wall 12 are fixed by glue.

Compared with the related technology, in the lens module according to the present utility model, the annular supporting member is provided at one end of the lens barrel that is adjacent to the image side, the annular supporting member and the lens barrel cooperate to surround the accommodation space for accommodating the lens group, and the minimum distance between the inner surface of the annular supporting member and the optical axis is greater than the maximum distance between the inner side surface of the second barrel wall and the optical axis, which may effectively reduce the incidence of the stray light on the annular supporting member, thereby reducing the stray light phenomenon inside the lens group and effectively improving the imaging quality. The annular supporting member and the second barrel wall may be cooperatively fixed by various means, and different dispensing fixation modes are used, which ensures flexibility of the design of the lens barrel bottom for free replacement and ensures good support of the lens barrel to the lens group for good reliability.

The above description is merely embodiments of the present disclosure, and it should be pointed out that, those of ordinary skills in the art are able to make improvements without departing from the inventive concept of the present disclosure, but these improvements all belong to the protection scope of the present disclosure.

What is claimed is:

1. A lens module, comprising a lens barrel with an accommodation space and a lens group accommodated in the accommodation space; the lens barrel comprising a first barrel wall configured with a light through hole and a second barrel wall bending and extending from an outer side of the first barrel wall; the lens module further comprising an annular supporting member fixed to one end of the second barrel wall that is adjacent to an image side; the annular supporting member, the second barrel wall, and the first barrel wall jointly surrounding to form the accommodation space; the second barrel wall comprising an inner side surface adjacent to an optical axis; the annular supporting member comprising an inner surface adjacent to the optical axis; and a minimum distance between the inner surface of the annular supporting member and the optical axis being greater than a maximum distance between the inner side surface of the second barrel wall and the optical axis.

2. The lens module according to claim 1, wherein the second barrel wall further comprises an outer side surface away from the optical axis, an end surface adjacent to the image side, and a step portion formed at the outer side surface and connected with the end surface; the step portion surrounds the accommodation space; and the annular supporting member abuts against and fixed on the step portion.

3. The lens module according to claim 2, wherein the step portion comprises a receiving surface connected with the outer side surface and extending horizontally in a direction adjacent to the optical axis, and a stop surface extending vertically from the receiving surface in the direction adjacent to the image side and connected with the end surface;
the annular supporting member further comprises a top surface adjacent to an object side and connected with the inner surface; the top surface abuts against the receiving surface, and the inner surface partially abuts against the stop surface.

4. The lens module according to claim 3, wherein the inner surface comprises a first surface connected with the top surface and abutting against the stop surface, a second surface extending horizontally from the first surface in the direction adjacent to the optical axis and abutting against the end surface, a third surface extending vertically from the second surface in the direction adjacent to the image side, a fourth surface extending horizontally from the third surface in the direction away from the optical axis, and a fifth surface extending vertically from the fourth surface in the direction adjacent to the image side;
the second surface abuts against the end surface and partially covers the end surface, an uncovered portion of the end surface forms a stepped structure with the third surface, the fourth surface, and the fifth surface; and the stepped structure serves as a dispensing groove for fixing the annular supporting member to the second barrel wall.

5. The lens module according to claim 3, wherein the inner surface comprises a sixth surface connected with the top surface and abutting against the stop surface, a seventh surface extending horizontally from the sixth surface in the direction away from the optical axis, and an eighth surface extending vertically from the seventh surface in the direction adjacent to the image side;
the eighth surface and the stop surface are arranged at intervals; the eighth surface, the seventh surface and the stop surface cooperate to surround a first groove; and the first groove serves as a dispensing groove for fixing the annular supporting member to the second barrel wall.

6. The lens module according to claim 2, wherein the step portion comprises a first supporting surface connected with the outer side surface and extending horizontally in a direction adjacent to the optical axis, a first stop surface extending vertically from the first supporting surface in the direction adjacent to the image side, a second supporting surface extending horizontally from the first stop surface in the direction adjacent to the optical axis, and a second stop surface extending vertically from the second supporting surface in the direction adjacent to the image side and connected with the end surface;
the annular supporting member further comprises a top surface adjacent to an object side and connected with the inner surface; the top surface abuts against the first supporting surface; and the inner surface comprises a first inner surface connected with the top surface and abutting against the first stop surface, a second inner surface extending horizontally from the first inner surface in the direction adjacent to the optical axis, a third inner surface extending vertically from the second inner surface in the direction adjacent to the image side and abutting against the second stop surface, a fourth inner surface extending horizontally from the third inner surface in the direction away from the optical axis, and a fifth inner surface extending vertically from the fourth inner surface in the direction adjacent to the image side;
the fifth inner surface and the second stop surface are arranged at intervals; the fifth inner surface, the fourth inner surface and the second stop surface cooperate to surround a second groove; and the second groove serves as a dispensing groove for fixing the annular supporting member to the second barrel wall.

7. The lens module according to claim 1, wherein the annular supporting member is made of a metal or plastic.

8. The lens module according to claim 1, wherein the annular supporting member and the second barrel wall are fixed by glue.

9. The lens module according to claim 1, wherein the lens module further comprises a press ring that holds the lens group in the accommodation space; and the press ring abuts against the inner side surface of the second barrel wall.

10. The lens module according to claim 9, wherein a third groove is formed between one side of the press ring that is adjacent to an image plane and the inner side surface of the second barrel wall; the third groove is filled with an adhesive; and the press ring is fixed to the second barrel wall by the adhesive.
